(19) United States
(12) Patent Application Publication
(10) Pub. No.: US 2003/0206742 A1
(43) Pub. Date: Nov. 6, 2003

(54) Compensation of disturbed polarized channels in an optical transmission system

(75) Inventor: Bernd Franz, Brackenheim (DE)

Correspondence Address: SUGHRUE MION, PLLC, 2100 PENNSYLVANIA AVENUE, N.W., WASHINGTON, DC, 20037, US

(73) Assignee: Alcatel

(21) Appl. No.: 10/423,957

(22) Filed: Apr. 28, 2003

(30) Foreign Application Priority Data
May 2, 2002 (EP) 02 360 142.0
Jun. 18, 2002 (EP) 02 360 177.6

(51) Int. Cl. H04J 14/02

(52) U.S. Cl. 398/81; 398/147

(57) ABSTRACT

A method for compensating signal distortions of signals polarized to each other in an optical wavelength division multiplex transmission system, comprising the steps of providing a first signal being obtained from a first polarized signal and a second signal being obtained from a second polarized signal, the first and second polarized signals being polarized with respect to each other, determining a first signal quality for the first signal, generating a first error signal in dependence of the first signal quality, and subtracting the first error signal from the first signal.

The invention is based on a priority application EP 02 360 142.0 and 02 360 177.6 which are hereby incorporated by reference.

### FIELD OF THE INVENTION

The present invention relates to polarization multiplexing in optical transmission systems and in particular to a compensation of non linear distortions occurring in channels used for polarization multiplexed transmissions.

### BACKGROUND OF THE INVENTION

In order to increase the transmission capacity of optical transmission systems, it is known to use wavelength division multiplexing (WDM) transmissions. For WDM transmissions, different signals communicated via the same transmission line (e.g. optical fiber) are transmitted at different wavelengths wherein the number of different frequencies determines the number of different signals which can be transmitted over the same transmission line at the same time.

Dense wavelength division multiplexing (DWDM) representing an enhanced WDM increases the transmission capacity by combining multiple optical signals such that they can be amplified and transmitted as a group and provides a higher spectral efficiency.

A further enhancement of the transmission capacity in optical transmission systems can be obtained by polarization division multiplexing (PoIDM) wherein different signals transmitted via the same transmission line are separated from each other by means of different polarization modes. Usually, polarization division multiplexing is combined with (D)WDM, wherein at least two signals, which are polarized with respect to each other, are transmitted at the same frequency.

A problem in optical transmission systems, in particular for optical transmission lines, such as optical fibers, is the phenomena of polarization mode dispersion (PMD). Optical signals transmitted via an optical transmission line are subjected to polarization mode dispersion such that the polarization state of the signals is altered.

Especially in the case of (D)WDM systems utilizing polarization division multiplexing, non-linear signal distortions on optical transmission lines especially due to polarization mode dispersions (PMD) represent a problem. For polarization division multiplexing, the polarization states of different signals are employed to separate the same for transmission. At the receiving end of an optical transmission line, the different polarizations of the signals are used as a basis to distinguish different signals in order to obtain the respective original signals. Polarization mode dispersion along the optical transmission line disturbs the polarization based encoding of the signals. Therefore, at the end of the optical transmission line, a correct decoding of the different signals can be impaired or even impossible.

Further, polarization mode dispersion disturbing the polarization state of signals transmitted via the same optical transmission line can introduce non linear signal distortions such as cross-talk between channels. This can also result in signals at the end of a transmission line from which the original signals can not be obtained.

A major cause of polarization mode dispersion are asymmetries and non-linearities of optical fibers used in transmission lines. Fiber asymmetry may be inherent from the manufacturing process or it may occur during operation, e.g. form mechanical stress, temperature variations, vibrations etc.

To compensate such effects it is known to use devices mechanically acting on optical fibers to “counter-stresses” the fibers. A drawback of such mechanical devices is that they are more prone to failure over long durations. Because of combinations of these effects, and the random manner these effects can interact, resulting polarization mode dispersion will vary for different parts of an optical transmission line and different frequencies and will be difficult to predict. Thus, it would be necessary to adapt such mechanical devices to actual polarization mode dispersion in a flexible and fast manner which requires complex and expensive mechanical arrangements.

A further approach is to employ special optical fibers which are dispersion-optimized and particularly tolerant to fiber non-linearities. Nevertheless, such fibers can not avoid polarization mode dispersion related signal distortions at all.

Moreover, polarization mode dispersion is also a function of the length of an optical transmission line, i.e. the longer the optical transmission line the larger the extend of polarization mode dispersion. As a result, the transmission distance which can be actually achieved is reduced. To reduce transmission length related polarization mode dispersion problems it is known to simply shorten optical transmission lengths. This can be accomplished, for example, by receiver/transmitter units distributed along a transmission line which decode optical signals and transmit new corresponding optical signals. Such receiver/transmitter units are merely regenerating optical signals and, in general, do not provide further functions. Further, this approach is not suitable to avoid polarization mode dispersion and related effects, but will only result in a minimization thereof.

Further, special frequency allocation schemes and methods are used to reduce polarization mode dispersion and related effects.

In general, a problem associated with approaches for compensating polarization mode dispersion is that polarization mode dispersion is not completely or at least not sufficiently avoided. Thus, polarization mode dispersion and related effects will continue to occur. Especially in systems wherein polarization mode dispersion compensation will be performed at the receiving end of a transmission line, this will represent a severe problem. There, it might be possible to at least sufficiently compensate polarization mode dispersion distortions, but distortions along the transmission line affected by polarization mode dispersion, such as cross-talk, will still be present. As a result it is possible that received signals, even in case of a perfect polarization mode dispersion compensation, are distorted such that underlying original signals and its information, respectively, can not be obtained.

The object of the present invention is to overcome polarization mode dispersion related problems in polarization division multiplex optical signal transmissions. In greater detail, the object of the present invention is to provide for solutions which allow for an enhanced compensation of polarization mode dispersions effects which affect polarization division multiplexed signals by non linear distortions, e.g. cross-talk.

### SUMMARY OF THE INVENTION

To achieve the above object, the present invention provides a method for compensating signal distortions of signals polarized to each other in an optical wavelength division multiplex transmission system. On the basis of a first signal being obtained from a first polarized signal and a second signal being obtained from a second polarized signal, the first and second polarized signal being polarized with respect to each other, a first signal quality for the first signal is determined. Then, in dependence of the first signal quality, a first error signal is generated which is subtracted from the first signal to compensate signal distortions thereof.

For a compensation of signal distortions of the second signal, it is possible to determine a second signal quality for the second signal and use the second signal quality to generate a second error signal in response thereto. By subtracting the second error signal from the second signal a compensated second signal is provided.

In a preferred embodiment, the first error signal is generated from the second signal and/or the second error signal is generated from the first signal.

In general, but preferably in the latter embodiment, the method according to the invention comprises determining a first attenuation and/or a first delay in dependence of the first signal quality and applying the first attenuation and/or the first delay to the second signal to obtain the first error signal, and/or determining a second attenuation and/or a second delay in dependence of the second signal quality and applying the second attenuation and/or the second delay to the first signal to obtain the second error signal.

According to a preferred further embodiment, the first error signal is generated from at least one of the first polarized signal and the second polarized signal and/or the second error signal is generated from at least one of the first polarized signal and the second polarized signal.

Here, it is contemplate to determine a first attenuation in dependence of the first signal quality, to compare the first attenuation with a first cross-talk value representing cross-talk disturbing at least one of the first and second signals and to generate the first error signal from at least one of the first polarized signal and the second polarized signal, if the comparing indicates a predetermined relation of the first attenuation and the first cross-talk value.

In a comparable manner, it is possible to determine a second attenuation in dependence of the second signal quality, to compare the second attenuation with a second cross-talk value representing cross-talk disturbing at least one of the first and second signals and to generate the second error signal from at least one of the first polarized signal and the second polarized signal, if the comparing indicates a predetermined relation of the second attenuation and the second cross-talk value.

With respect to a signal quality assessment is possible to determine the first signal quality by assessing the signal quality of a signal being obtained by subtracting the first error signal from the first signal and/or to determine the second signal quality by assessing the signal quality of a signal being obtained by subtracting the second error signal from the second signal.

In order to obtain the first signal, it is contemplated to include polarization demultiplexing the first polarized signal or polarization demultiplexing and wavelength demultiplexing the first polarized signal.

In a similar way, the second signal can be obtained by polarization demultiplexing the second polarized signal or polarization demultiplexing and wavelength demultiplexing the second polarized signal.

Preferably, the polarization demultiplexing of the first polarized and/or the second polarized signal is respectively performed on the basis of measures indicating a polarization signal quality for the first signal and the second signal, respectively.

Further, the present invention provides an apparatus according to claim 9 for compensation of signal distortions of signals polarized to each other in an optical wavelength division multiplex transmission system. The apparatus according to the invention comprises a first unit for determination of a first signal quality for a first signal obtained from a first polarized signal, a first error signal generating unit for generation of a first error signal, and a first signal distortion compensation unit for subtraction of the first error signal from the first signal obtained from the second polarized signal, wherein the first and second polarized signal are polarized with respect to each other.

Preferably, the apparatus according to the invention comprises further a second unit for determination of a second signal quality for the second signal, a second error signal generating unit for generation of a second error signal, and a second signal distortion compensation unit for subtraction of the second error signal from the second signal.

For obtaining, which includes receiving, extracting, detecting of signals and the like, it is contemplated to employ a first unit for providing the first signal and a second unit for providing the second signal.

According to a preferred embodiment, the first error signal generating unit is adapted for a generation of the first error signal from the first signal, while, in addition or as an option, the second error signal generating unit is adapted for a generation of the second error signal from the first signal.

In general, but preferably for the latter mentioned embodiment, the first error signal generating unit is adapted of a determination a first attenuation and/or a first delay in dependence of the first signal quality and applying the first attenuation and/or the first delay to the first signal to obtain the first error signal, and/or the second error signal generating unit is adapted of a determination a second attenuation and/or a second delay in dependence of the second signal quality and applying the second attenuation and/or the second delay to the second signal to obtain the second error signal.

According to a preferred further embodiment, the first error signal generating unit is adapted of a determination of a first attenuation in dependence of the first signal quality, comparing the first attenuation with a first cross-talk value representing cross-talk disturbing at least one of first and second signals and generating the first error signal from at least one of the first polarized signal and the second polarized signal, if a predetermined relation of the first attenuation and the first cross-talk value is present.

In a comparable manner, it is possible that the second error signal generating unit is adapted of a determination of a second attenuation in dependence of the second signal quality, comparing the second attenuation with a second cross-talk value representing cross-talk disturbing at least one of first and second signals and generating the second error signal from at least one of the first polarized signal and the second polarized signal, if a predetermined relation of the second attenuation and the second cross-talk value is present.

Moreover, the first unit for determination of the first signal quality can be in communication with the first signal distortion compensation unit for a determination of the first signal quality for a signal from the first signal distortion compensation unit, and/or the second unit for determination of the second signal quality can be in communication with the second signal distortion compensation unit for a determination of the second signal quality for a signal from the second signal distortion compensation unit.

Additionally, units for polarization demultiplexing and/or wavelength demultiplexing of at least one of the first and second polarized signal can be included.

Here, it is preferred that a first polarization demultiplexing unit is in communication with the first unit for determination of the first signal quality for a polarization demultiplexing of the first polarized signal in dependence of the first signal quality.

### BRIEF DESCRIPTION OF THE DRAWINGS

In the following description of preferred embodiments of the present invention it is referred to the accompanying figures wherein:

FIG. 1 schematically illustrates a receiver arrangement for compensating quasi-orthogonally polarized and disturbed signals according to the present invention, and

### DESCRIPTION OF PREFERRED EMBODIMENTS

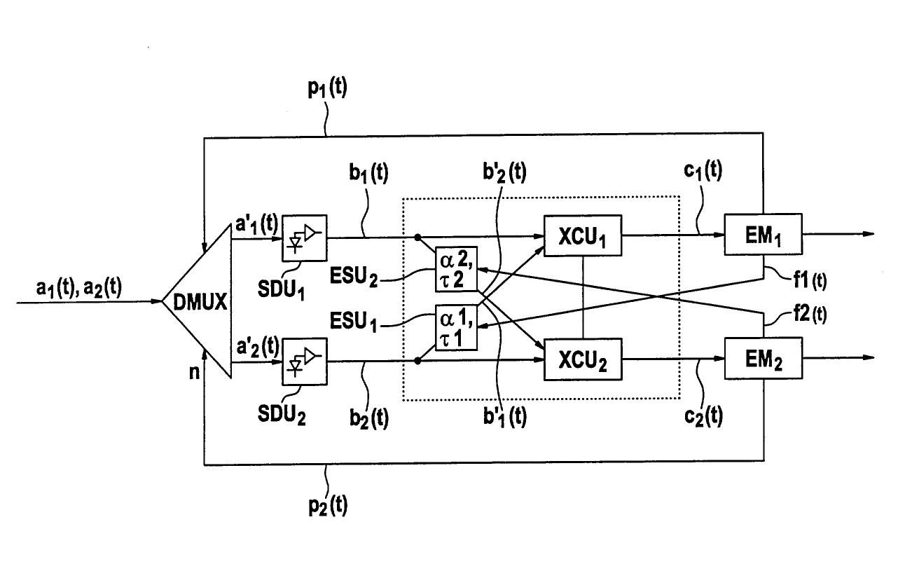

In the following description, an (D)WDM transmission system is assumed wherein signals are transmitted via an optical transmission line by means of polarization division multiplexing. Signals are transmitted via different channels, wherein each channel is used to transmit at least two different signals which have different polarization states at the same wavelengths. Referring to FIG. 1, the description is directed to a transmission of two signals at the same wavelength wherein the two signals are, preferably orthogonally (at the transmitter), polarized with respect to each other.

FIG. 1 schematically illustrates a receiving arrangement for receiving polarized signals of a common (D)WDM channel. For the above assumed transmission system, two signals a₁(t) and a₂(t) are received wherein these signals are polarized with respect to each other.

The signals a₁(t) and a₂(t) are received by a polarization demultiplexer DMUX and separated by demultiplexing using polarization filters. Further, the polarization demultiplexer DMUX receives feedback signals p₁(t) and p₂(t) used as control signals for the demultiplexing of the received signals a₁(t) and a₂(t).

The operation of the polarization demultiplexer DMUX is optimized in relation to the demultiplexing of the received signals a₁(t) and a₂(t) by means of the feedback signals p₁(t) and p₂(t). In particular, the feedback signals p₁(t) and p₂(t) are employed to control the polarization state of the polarization demultiplexer DMUX and, especially, its polarization filters.

For obtaining the feedback signals p₁(t) and p₂(t), eye monitors EM₁ and EM₂ or any other suitable quality measuring units which provide for an assessment a signal quality can be used.

The polarization demultiplexer DMUX generates two output signals a′₁(t) and a′₂(t) each thereof being supplied to signal detections units SDU₁ and SDU₂. The signal detections units SDU₁ and SDU₂ are used to convert the optical output signals a′₁(t) and a′₂(t) of the polarization demultiplexer DMUX into two corresponding electrical signals b₁(t) and b₂(t).

Non linear distortions along the optical transmission line and especially polarization mode dispersions and cross-talk effects disturb the polarization state of the signals a₁(t) and a₂(t). As a result, the signals b₁(t) and b₂(t) will also be subjected to non linear signal distortions.

Polarization mode dispersion (PMD) is treated by means of the closed control loops providing the feedback signals p₁(t) and p₂(t) associated to the demultiplexing processes of the received signals a₁(t) and a₂(t). The eye monitors EM₁ and EM₂ evaluate the quality of signals, which are derived on the basis of a₁(t) and a₂(t) and supplied to the eye monitors EM₁ and EM₂, with respect to its polarization states and supply the feedback signals p₁(t) and p₂(t) to the polarization demultiplexer DMUX for controlling the polarization demultiplexing of the signals a₁(t) and a₂(t).

Nevertheless, it is possible that the resulting signals a′₁(t) and a′₂(t) will still be distorted, in particular due to cross-talk effects.

As shown in FIG. 1, cross-talk canceling units XCU₁ and XCU₂ are employed to compensate for cross-talk effects. In general, the cross-talk canceling units XCU₁ and XCU₂ serve as units for applying error signals to the signals b₁(t) and b₂(t), respectively such that signal distortions are at least partially compensated.

The cross-talk canceling unit XCU₁ receives the signal b₁(t) and an error signal b′₁(t) from an error signal generating unit ESU₁. The error signal generating unit ESU₁ receives the signal b₂(t) and modifies the signal b₂(t) in dependence from at least one of parameters α1 and τ1 to obtain the error signal b′₂(t). As output signal, the cross-talk canceling unit XCU₁ generates a signal c₁(t) which represents, at least as an approximation, the original signal underlying the received signal a₁(t). In greater detail, the signal c₁(t) is corrected with respect to polarization mode dispersions and cross-talk effects.

The cross-talk canceling unit XCU₂ receives the signal b₂(t) and an error signal b′₁(t) from an error signal generating unit ESU₂. The error signal generating unit ESU₂ receives the signal b₁(t) and modifies the signal b₁(t) in dependence from at least one of parameters α2 and τ2 to obtain the error signal b′₁(t). As output signal, the cross-talk canceling unit XCU₂ generates a signal c₂(t) which represents, at least as an approximation, the original signal underlying the received signal a₂(t). In greater detail, the signal c₂(t) is corrected with respect to polarization mode dispersions and cross-talk effects.

The parameters α1/τ1 and α2/τ2 are provided by the eye monitors EM₁ and EM₂, respectively, by means of feedback signals f1(t) and f2(t) respectively supplied to the error signal generating units ESU₁ and ESU₂ The parameters α1 and α2 indicate attenuations and the parameters τ1 and □2 indicate delays to be applied to the signals b₁(t) and b₂(t).

For obtaining the parameters α1 and τ1, the eye monitor EM₁ is provided the signal c₁(t) and evaluates the quality of the signal c₁(t). In response to the detected signal quality for the signal c₁(t), the eye monitor EM₁ controls the parameters α1 and τ1, in particular such that an optimal eye opening is achieved for the signal c₁(t).

In a comparable manner, for obtaining the parameters α2 and τ2, the eye monitor EM₂ is provided the signal c₂(t) and evaluates the quality of the signal c₂(t). In response to the detected signal quality for the signal c₂(t), the eye monitor EM₂ controls the parameters α2 and τ2, in particular such that an optimal eye opening is achieved for the signal c₂(t).

The signals c₁(t) and c₂(t) generated by cross-talk canceling units XCU₁ and XCU₂ can be defined as:

c₁(t)=b₁(t)−b′₂(τ2)=a₁*b₂(t+τ1) and (3)

c₂(t)=b₂(t)−b′₁(τ1)=α₂*b₁(t+τ2). (4)

Here, the cross-talk canceling units XCU₁ and XCU₂ can be considered as subtracting units for the signals b₁(t) and b₂(t) and the error signals b′₁(t) and b′₂(t), respectively.

Simulations performed for the above described receiving arrangement for optical transmissions employing WDM and PoIDM have shown that cross-talk can be reduced by several decibel.

For transmission systems wherein the following assumptions are fulfilled, e.g. due to any other means or measures reducing non linear effects which distort orthogonally polarized signals, further embodiments described in the following can be employed to generate the signals c₁(t) and c₂(t) in order to obtain the signals underlying the received signals a₁(t) and a₂(t).

First, assuming no delay or time shift is to be applied to the signal b₂(t) to obtain the error signal b′₂(t) and further assuming the above named parameter α indicating cross-talk between the signals a₁(t) and a₂(t) corresponds with the parameter α₁ representing the attenuation for the signal b₂(t), the signal c₁(t) can be defined as:

$$\begin{matrix}{c}_{1} ( t ) = {b}_{1} ( t ) - {α}^{*} {b}_{2} ( t ) = \\ {( 1 - α - {α}^{2} )}^{*} {a}_{1} ( t ) + {α}^{2} {}_{}^{*}{α}{}_{2}^{} ( t ) = \\ {a}_{1} ( t ) - ( ( α + {α}^{2} ) {}_{}^{*}{a}{}_{1}^{} ( t ) - {α}^{2} {}_{}^{*}{a}{}_{2}^{} ( t ) ) ,\end{matrix} \qquad ( 5 )$$

wherein the signal component “(α+α²)*a₁(t)−α²*a₂(t)” can be considered as error signal for compensating signal distortions of the signal a₁(t).

In a comparable manner, assuming no delay or time shift is to applied to the signal b₁(t) to obtain the error signal b′₁(t) and further assuming the above named parameter α indicating cross-talk between the signals a₁(t) and a₂(t) corresponds with the parameter α₁ representing the attenuation for the signal b₁(t), the signal c₂(t) can be defined as:

$$\begin{matrix}{c}_{2} ( t ) = {b}_{2} ( t ) - {α}^{*} {b}_{1} ( t ) = \\ ( 1 - α - {α}^{2} ) {}_{}^{*}{a}{}_{2}^{} ( t ) + {α}^{2} {}_{}^{*}{a}{}_{1}^{} ( t ) = \\ {a}_{2} ( t ) - ( ( α + {α}^{2} ) {}_{}^{*}{a}{}_{2}^{} ( t ) - {α}^{2} {}_{}^{*}{a}{}_{1}^{} ( t ) ) ,\end{matrix} \qquad ( 6 )$$

wherein the signal component “(α+α²)*a₂(t)−α²*a₁(t)” can be considered as error signal for compensating signal distortions of the signal a₂(t).

Thus, the cross-talk canceling units XCU₁ and XCU₂ can be considered as subtracting units for the signals b₁(t) and b₂(t) and the respective error signals.

Second, assuming no delay or time shift is to be applied to the signal b₂(t) to obtain the error signal b′₂(t) and further assuming the parameter α₁ representing the attenuation for the signal b₂(t) corresponds with α/(1−α), α being the above named parameter indicating cross-talk between the signals a₁(t) and a₂(t), the signal c₁(t) can be defined as:

$$\begin{matrix}{c}_{1} ( t ) = {b}_{1} ( t ) - α / {( 1 - α )}^{*} {b}_{2} ( t ) = \\ {( 1 - α - {α}^{2} / ( 1 - α ) )}^{*} {a}_{1} ( t ) = \\ {a}_{1} ( t ) - ( α + {α}^{2} / ( 1 - α ) ) {}_{}^{*}{a}{}_{1}^{} ( t ) ,\end{matrix} \qquad ( 7 )$$

wherein the signal component “(α+α²/(1−α))*a₁(t)” can be considered as error signal for compensating signal distortions of the signal a₁(t).

In a comparable manner, assuming no delay or time shift is to be applied to the signal b₂(t) to obtain the error signal b′₂(t) and further assuming the parameter α₁ representing the attenuation for the signal b₁(t) corresponds with α/(1−α), a being the above named parameter indicating cross-talk between the signals a₁(t) and a₂(t), the signal c₂(t) can be defined as:

$$\begin{matrix}{c}_{2} ( t ) = {b}_{2} ( t ) - α / ( 1 - α ) {}_{}^{*}{b}{}_{1}^{} ( t ) = \\ ( 1 - α - {α}^{2} / ( 1 - α ) ) {}_{}^{*}{a}{}_{2}^{} ( t ) = \\ {a}_{2} ( t ) - ( α + {α}^{2} / ( 1 - α ) ) {}_{}^{*}{a}{}_{2}^{} ( t ) ,\end{matrix} \qquad ( 8 )$$

wherein the signal component “(α+α²/(1−α))*α₂(t)” can be considered as error signal for compensating signal distortions of the signal a₂(t).

Again, the cross-talk canceling units XCU₁ and XCU₂ can be considered as subtracting units for the signals b₁(t) and b₂(t) and the respective error signals.

Starting from the above further embodiments, a further embodiment can be employed in case of a small value for α is existing or can be expected. Then, the following approximations for equations (5) and (7) and equations (6) and (8) can be used to obtain the signals c₁(t) and c₂(t):

c₁(t)=(1−α)*a₁(t) and (10)

c₂(t)=(1−α)*a₂(t), (11)

wherein the signal components “α*a₁(t)” and “α*a₂(t)” can be considered as error signal for compensating signal distortions of the signal a₁(t) and a₂(t), respectively. Thus, in this case, the cross-talk canceling units XCU₁ and XCU₂ can also be considered as subtracting units for the signals b₁(t) and b₂(t) and the respective error signals.

An additional improvement of the method can be obtained by shifting the optical phase between the two orthogonal polarized signals in such a way, that an optimal result (measured at the receiver) is obtained.

Before combining the two orthogonal polarized signals one signals is fed in an optical phase shifter. The phase shifter shifts the signal in relation of a feed back signal, which is extracted from the receiver side. On the receiver side, the two orthogonal signals are analyzed by eye monitors and the result of the analysis controls the phase shifters at the transmitter side.

1. A method for compensating signal distortions of signals polarized to each other in an optical wavelength division multiplex transmission system, comprising the steps of:
providing a first signal being obtained from a first polarized signal and a second signal being obtained from a second polarized signal, the first and second polarized signals being polarized with respect to each other,
determining a first signal quality (for the first signal,
generating a first error signal in dependence of the first signal quality, and
subtracting the first error signal from the first signal.

2. The method according to claim 1, comprising the steps of:
determining a second signal quality for the second signal,
generating a second error signal in dependence of the second signal quality, and
subtracting the second error signal from the second signal.

3. The method according to claim 1, comprising the steps of:
generating the first error signal from the first signal, and/or
generating the second error signal from the second signal.

4. The method according to one of the preceding claims, comprising the steps of:
determining a first attenuation and/or a first delay in dependence of the first signal quality and applying the first attenuation and/or the first delay to the first signal to obtain the first error signal, and/or
determining a second attenuation and/or a second delay in dependence of the second signal quality and applying the second attenuation and/or the second delay to the second signal to obtain the second error signal.

5. The method according to claim 4, comprising the steps of:
determining a first attenuation in dependence of the first signal quality, comparing the first attenuation with a first cross-talk value representing cross-talk disturbing at least one of the first and second signals and generating the first error signal from at least one of the first polarized signal and the second polarized signal, if the comparing indicates a predetermined relation of the first attenuation and the first cross-talk value, and/or
determining a second attenuation in dependence of the second signal quality, comparing the second attenuation with a second cross-talk value representing cross-talk disturbing at least one of the first and second signals and generating the second error signal from at least one of the first polarized signal and the second polarized signal, if the comparing indicates a predetermined relation of the second attenuation and the second cross-talk value.

6. The method according to claim 1, comprising the steps of:
determining the first signal quality by determining a signal quality of a signal being obtained by subtracting the second error signal from the first signal, and/or
determining the second signal quality by determining a signal quality of a signal being obtained by subtracting the first error signal from the first signal.

7. The method according to claim 1, comprising the steps of:
polarization demultiplexing the first polarized signal or polarization demultiplexing and wavelength demultiplexing the first polarized signal (a₁(t)) to obtain the first signal, and
polarization demultiplexing the second polarized signal or polarization demultiplexing and wavelength demultiplexing the second polarized signal to obtain the second signal.

8. The method according to claim 7, comprising the steps of:
determining a first polarization signal quality for the first signal and polarization demultiplexing the first polarized signal in dependence of the first polarization signal quality, and/or
determining a second polarization signal quality for the second signal and polarization demultiplexing the second polarized signal in dependence of the second polarization signal quality.

9. An apparatus for compensation of signal distortions of signals polarized to each other in an optical wavelength division multiplex transmission system, comprising:
a first unit for determination of a first signal quality for a first signal obtained from a first polarized signal,
a first error signal generating unit for generation of a first error signal, and
a first signal distortion compensation unit for subtraction of the first error signal from a second signal obtained from a second polarized signal, the first and second polarized signal being polarized with respect to each other.

10. The apparatus according to claim 9, comprising:
a second unit for determination of a second signal quality for the second signal,
a second error signal generating unit for generation of a second error signal, and
a second signal distortion compensation unit for subtraction of the second error signal from the first signal.

11. The apparatus according to claim 9, wherein:
the first error signal generating unit is adapted of a determination a first attenuation and/or a first delay in dependence of the first signal quality and applying the first attenuation and/or the first delay to the first signal to obtain the first error signal, and/or
the second error signal generating unit is adapted of a determination a second attenuation and/or a second delay in dependence of the second signal quality and applying the second attenuation and/or the second delay to the second signal to obtain the second error signal.

12. The apparatus according to claim 9, wherein:
the first error signal generating unit is adapted of a determination a first attenuation in dependence of the first signal quality, comparing the first attenuation with a first cross-talk value representing cross-talk disturbing at least one of the first and second signals and generating the first error signal from at least one of the first polarized signal and the second polarized signal, if a predetermined relation of the first attenuation and the first cross-talk value is present, and/or
the second error signal generating unit is adapted of a determination a second attenuation in dependence of the second signal quality, comparing the second attenuation with a second cross-talk value representing cross-talk disturbing at least one the first and second signals and generating the second error signal from at least one of the first polarized signal and the second polarized signal, if a predetermined relation of the second attenuation and the second cross-talk value is present.

13. The apparatus according to to claim 9, wherein:
the first unit for determination of the first signal quality is in communication with the first signal distortion compensation unit for a determination of the first signal quality for a signal from the second signal distortion compensation unit, and/or
the second unit for determination of the second signal quality is in communication with the second signal distortion compensation unit for a determination of the second signal quality for a signal from the second signal distortion compensation unit.
